(19) United States
(12) Patent Application Publication
(10) Pub. No.: US 2026/0307108 A1
(43) Pub. Date: Oct. 8, 2026

(54) SORTING DEVICE FOR A STORAGE SYSTEM AND STORAGE SYSTEM WITH SORTING DEVICE

(71) Applicant: SorTec Pharma Sortiertechnik GmbH, Wolpertshausen (DE)

(72) Inventors: Günter Eisenmann, Ilshofen (DE); Thomas Ottenwälder, Stimpfach (DE)

(73) Assignee: SorTec Pharma Sortiertechnik GmbH, Wolpertshausen (DE)

(21) Appl. No.: 19/636,407

(22) Filed: Apr. 1, 2026

(30) Foreign Application Priority Data
Apr. 2, 2025 (DE) 102025112996.7
Jun. 11, 2025 (DE) 102025122706.3

(51) Int. Cl. B07B 13/04; B07B 13/16

(52) U.S. Cl. CPC B07B 13/04; B07B 13/16

(57) ABSTRACT

The subject matter of the present invention relates to a sorting device (6) for a storage system (1) for small parts, in particular for closure elements, wherein the sorting device (6) is configured to separate small parts that are stuck together and/or to sort out small parts that are stuck together. In addition, the subject matter of the present invention relates to a storage system (1) for small parts, in particular for closure elements, with at least one sorting device.

### CROSS-REFERENCE TO RELATED APPLICATION

The present application claims priority to German Patent Application No. 102025112996.7, filed Apr. 2, 2025, and German Patent Application No. 102025122706.3, filed Jun. 11, 2025, the entirety of both of which are incorporated herein by reference.

### TECHNICAL FIELD

The invention relates to a sorting device for a storage system for small parts, in particular for closure elements, for example for stoppers. In addition, the invention relates to a storage system for small parts with a sorting device.

Stoppers are, in particular, closure elements for containers, for example for pharmaceutical containers such as vials, syringes, cartridges, or ampoules, which are used to seal the containers. The stoppers are inserted into the containers in particular. The stoppers are made of plastic, for example. Particular materials are intended for the manufacture of stoppers, particularly for pharmaceutical applications.

### OBJECT AND SOLUTION

The objectives of the invention are to create an improved sorting device and an improved storage system for small parts.

According to a first aspect, a sorting device is provided for a storage system for small parts, in particular for closure elements, for example for stoppers, wherein the sorting device is configured to separate small parts adhering to one another and/or to sort out small parts adhering to one another.

The sorting device is configured to separate small parts, in particular in the form of stoppers, closures, and the like, at an outlet of a storage system for subsequent feeding to a feeding system. The small parts, in particular the stoppers, have at least one cylindrical or conical section in their design, which is inserted into containers for sealing. In some embodiments, the cylindrical or conical section protrudes from a head part or head section. Other shapes of the section protruding from the head part are possible. In some embodiments, the stoppers do not have a head section. The small parts are designed to be rotationally symmetrical, for example, around a rotational axis extending in the longitudinal direction of the small part. In some embodiments, the small parts are made of rubber, caoutchouc, or plastic. For example, the small parts are made of a material approved for packaging materials for pharmaceutical products, in particular plastic.

The small parts are fed into the storage system, particularly as bulk material.

The sorting device is configured to separate and/or sort out elements adhering to one another or stuck together from small parts that are fed in bulk or stored in the storage system. As bulk goods, the small parts are stored in a disorderly manner or are removed in a disorderly manner from a storage container in the storage system. Two or more small parts may adhere to one another or stick together. Small parts that adhere to one another are also referred to as bonded small parts. Small plastic parts in particular tend to adhere to one another or “stick together”. Small parts that adhere to one another can cause disruptions in a process flow on a system that uses small parts.

At least two small parts may adhere to one another in different areas of the small parts. For example, the small parts can adhere to each other sideways and/or at or on the ends of a cylindrical small part. If the small parts have head parts, the small parts can also adhere to one another at the head parts. The alignment and/or orientation of the adhering small parts is irregular, with individual small parts also being isolated but undefined in their orientation. The two or more small parts that adhere to one another may also be undefined in their collective orientation and thus differ from one another.

The sorting device, which is configured to separate small parts adhering to one another and/or to sort out small parts adhering to one another, can reduce the number of small parts adhering to one another at an outlet. In particular, in embodiments, the it is prevented that small parts adhering to one another are being discharged at an outlet of the storage system. In particular, with the sorting device an increased output and/or a reduction in errors at the subsequent feeding device can be achieved.

In embodiments, several sorting devices are provided.

In embodiments, the sorting device is configured in such a way that it can be retrofitted to existing storage systems and/or easily removed and reattached for maintenance and/or cleaning purposes, for example for autoclaving, in particular without the need for tools.

The sorting device is configured so that, on the one hand, it allows individual small parts to pass through to subsequent devices and/or does not allow non-individual small parts to pass through, or so that it separates the transport paths of the individual small parts and the non-individual small parts.

In some embodiments, the sorting device comprises a limiting device, wherein the limiting device limits a gap. In embodiments, the gap is dimensioned in such a way as to allow individual small parts, in particular closure elements such as stoppers, to enter the gap and/or to prevent small parts, in particular closure elements such as stoppers, adhering to one another from entering the gap.

In some embodiments, the sorting device is provided with a separating device, wherein the separating device has at least one passage opening, in particular two or more passage openings, for example a plurality of passage openings. The separating device has, in particular, a conveyor surface, with the at least one passage opening being formed on the conveyor surface. The separating device in particular is arranged between a storage container and a conveyor chute of the storage system. The separating device is also referred to as a screening device.

In embodiments, the gap is formed in configurations between the separating device and the limiting device. The limiting device must be distinguished from the lateral limit, which is configured in particular as a side wall. While the lateral limit is arranged laterally on an inlet, a conveyor surface, and/or a reject outlet and protrudes transversely from each of these, the limiting device is arranged below and/or above the conveyor surface, i.e., on the side facing away from the feed or on the side facing the feed, at a distance from the conveyor surface. The distance between the limiting device, in particular a plate-shaped section of the limiting device, and the underside and/or upper side of the separating device is dimensioned such that it corresponds approximately to the greatest extension of a small part to be separated.

A limiting device arranged above the separating device is located upstream of the at least one passage opening. In particular, the limiting device is dimensioned in such a way that only isolated small parts can pass through the limiting device to the passage opening.

A limiting device arranged below the separating device is arranged downstream of the at least one passage opening. A limiting device arranged on below the separating device prevents, for example, two small parts that adhere to one another in their greatest extension but are oriented in a defined manner from passing through the respective passage opening of the separating device. Rather, the limiting device prevents such stuck or adhering small parts from passing through until they are separated from each other. For example, a small part protruding from the separating device in the direction of the limiting device is separated from a small part adhering to it by interaction with other small parts, which are moved in the gap in the direction toward an outlet. After separating the small parts, the two or more small parts can each pass through the passage opening, enter the gap between the limiting device and the separating device, and be transported further.

With a limiting device arranged above the separating device, it is ensured that only isolated small parts reach the passage opening arranged downstream of the gap.

The passage openings are dimensioned in such a way as to allow small parts, in particular closure elements such as stoppers, to pass through individually. The passage openings are dimensioned in such a way as to separate small parts, in particular closure elements such as stoppers, that adhere to one another and/or to retain small parts, in particular closure elements such as stoppers, that adhere to one another. The retained elements can subsequently pass through downstream-located passage openings. Retained elements that do not pass through the passage opening can be discharged. In some embodiments, the small parts are fed as bulk material to the sorting device, in embodiments to one side of the separating device, for example from a storage container in the storage system. The passage openings are dimensioned in such a way that they only allow the passage of individual, small parts that are, for example, also oriented in a defined manner. Small parts that adhere to one another and are not separated cannot pass through the separating device, or more precisely its passage openings, regardless of how the small parts are arranged in relation to each other. Such adhering and/or undefined small parts remain on the side of the sorting device or separating device until they are separated, defined, and/or sorted out. The isolated, and for example defined oriented small parts pass through the passage openings of the separating device and exit the sorting or separating device on the side opposite to the feed side. The passage openings may be arranged in a pattern relative to each other. Preferably, the adjacent passage openings are arranged equidistantly from each other. In some embodiments, at least two adjacent passage openings are not arranged equidistantly from each other.

In some embodiments, the separating device is configured to have a conveyor surface with at least one passage opening, in particular with the passage openings. In some embodiments, the separating device further comprises an inlet, wherein the inlet is arranged at an angle to the conveyor surface and forms a chute to the conveyor surface. The conveyor surface and the inlet are preferably connected to each other in one piece, but may also be configured in several parts. The inlet preferably has no passage openings. The conveyor surface preferably has at least one passage opening, for example the passage openings.

Preferably, the separating device has a lateral limit, particularly in the form of a side wall, at least in the area of the conveyor surface, in embodiments in the area of the conveyor surface and the inlet. The lateral limit prevents small parts from falling out of the separating device. Preferably, the lateral limit, more precisely the side wall, is interrupted at one point to form a reject outlet. It is preferable for the interruption to be configured in the direction of transport of the small parts behind or downstream of the conveyor surface. The inlet is located upstream of the conveyor surface in the direction of conveyance. In embodiments, the lateral limit, the inlet, the conveyor surface, and the reject outlet are configured as a single piece. In other embodiments, at least one of the inlet, the conveyor surface, the reject outlet, and the lateral limit is formed separately and/or is connectable to the other section(s).

In some embodiments, the limiting device is arranged below the separating device in a working orientation of the sorting device. Below means facing a side that is opposite to the side intended for feeding, or also downstream of the separating device in the direction of transport of the separated small parts. In some embodiments, a limiting device may additionally or alternatively be provided on the side intended for feeding in order to prevent or at least reduce the feeding of small parts adhering to one another with a height exceeding a certain size. The limiting device is arranged in such a way that it prevents small parts that have not been separated from passing through the passage openings of the separating device and/or the gap.

In some embodiments, the limiting device is arranged above the separating device in a working orientation of the sorting device. A gap formed by the limiting device is arranged in particular in the conveyor device upstream of the at least one passage opening, so that small parts can only reach the passage opening via the gap. The limiting device is arranged in particular in such a way that it covers a passage opening, forming a gap, so that small parts can only reach the passage opening via a gap formed between the limiting device and the separating device. Small parts that are not isolated, for example, adhering to one another, cannot pass through the gap and are retained. In particular embodiments, the following small parts exert a force on retained, adhering small parts, causing the small parts adhering to one another to separate so that they can pass through the gap. In some embodiments, the width of the limiting device transverse to a conveying direction of the small parts is smaller than the width of the separating device. Small parts that do not pass through the gap can pass through the side of the limiting device. Small parts that pass through the limiting device do not reach a passage opening of the separating device located downstream of the limiting device and thus do not reach a conveyor chute. In some embodiments, the separating device has at least one further passage opening, with a further limiting device provided upstream of the passage opening. Small parts that do not pass through a gap formed by a limiting device do not reach the conveyor chute. These small parts can be ejected, for example.

In some embodiments, the separating device is provided with a reject outlet. In some embodiments, the reject outlet points in a direction that deviates from the direction of conveyance and/or is arranged in a plane that deviates from a conveyor chute. For example, the reject outlet is arranged transversely to a conveying direction of the small parts along the passage openings. Small parts that do not pass through the separating device because they adhere to one another are discharged via a reject outlet. This prevents these small parts that are to be sorted out from accumulating on the separating device and, in particular, from blocking the passage openings of the separating device.

According to a further aspect of the invention, a storage system for small parts, in particular for closure elements, is provided with a sorting device described herein. The storage system is configured for storing small parts delivered as bulk goods, in particular for closure elements with a cylindrical or conical section, for example for stoppers. The small parts are made of a plastic that tends to have the small parts stick together or adhere to one another, for example. However, the storage system can also be used for small parts made of other materials.

In some embodiments, the storage system comprises a storage container and a conveyor chute, wherein the sorting device is arranged in the conveyor direction of the conveyor chute between the storage container and the conveyor chute, wherein, in particular, the sorting device is arranged above the conveyor chute in a working orientation. Small parts delivered or provided as bulk goods are stored in the storage container. The storage container preferably has a base and a side wall for storing the small parts. The base preferably has a feed surface via which the small parts can be fed from the storage container to further downstream devices, such as the sorting device. The feed surface is configured, for example, as a relatively movable base recess. In other embodiments, the feed surface is configured as a chute, in particular as a relatively immovable chute. The small parts are fed onto the feed surface through an opening in the base and from there to downstream equipment in the direction of conveyance. In addition, the storage system has one or more conveyor chutes through which the small parts can be transported from the storage system to the downstream equipment. The respective conveyor chute can have a cross-section adapted to the small parts. In addition, the storage system comprises a sorting device. The sorting device is arranged between the storage container and the conveyor chute or chutes in the direction of transport of the small parts. This ensures that every small part from the storage container must pass through the sorting device before reaching the conveyor chute and any downstream equipment. Small parts that do not leave the sorting device in the intended transport direction, i.e., that remain in the sorting device or are transported away via the reject outlet, do not reach the conveyor chute and any downstream devices. To ensure transport is as simple and energy efficient as possible, the storage container, or more precisely its base, the sorting device, and the conveyor chute are located at different height levels. The storage container has the highest height level and the conveyor chute has the lowest height level. The sorting device is arranged in between at an intermediate height level. Gravity can thus be used at least to assist in transporting the small parts from the storage container to the at least one conveyor chute. The arrangement corresponds to the arrangement in a working orientation.

In addition to gravity, the storage system may have additional drive devices or actuators, or drives for short. For example, a drive is operatively connected to the conveyor chute and/or the sorting device. In some embodiments, a drive is operatively connected to the conveyor chute, and the sorting device is operatively connected to the conveyor chute. The drive is configured as a drive that causes the conveyor chute to vibrate in order to move the small parts in a conveying direction. The oscillating motion is transferred to the sorting device. The oscillating motion supports the separating function of the sorting device for separating small parts.

In some embodiments, the sorting device is attached to the conveyor chute. Preferably, the sorting device is detachably attached to the conveyor chute. In some embodiments, the sorting device is permanently attached to the conveyor chute. In preferred embodiments, the sorting device is coupled to the conveyor chute using connecting elements, for example, tabs, screws, projections, recesses, and other coupling elements and the like. The sorting device is preferably arranged on one side of the conveyor chute opposite the side on which the drive is operatively connected to the conveyor chute.

In some embodiments, the sorting device comprises at least one of a separating device and a limiting device. The limiting device is arranged in configurations between the separating device and the conveyor chute. In embodiments, the limiting device is arranged between the storage container and the conveyor chute in the transport direction of the small parts. The limiting device is arranged in embodiments on a side of the separating device facing away from the conveyor chute, in particular upstream of a passage opening of the separating device.

The sorting and/or separation of small parts is preferably carried out according to the following method. In a first step, small parts are provided. These are preferably provided as bulk goods. Provisioning can be done in any way. Preferably, provision is made via the storage system described here, in particular via the storage container. The small parts provided are fed to the sorting device in a subsequent step. In the sorting device, the small parts are separated and thus isolated and fed into a conveyor chute, for example. The small parts that are not separated are sorted out in particular via a reject outlet. To assist separation, the conveyor is set into vibration. This is preferably done via the drive. To prevent small parts that adhere to one another from passing through the passage openings in the sorting device, in embodiments the passage through the passage openings in the sorting device is limited by a limiting device. The limiting device is configured in such a way that only isolated small parts pass through the passage openings and enter a gap between the conveyor surface and the limiting device. The separated small parts are fed into a conveyor chute from the gap. In particular embodiments, the limit is such that only isolated small parts that pass through a gap limited by a limiting device reach the passage openings of the separating surface and thus the conveyor chute. The small parts are transported by gravity and/or the vibrations generated by the drive. The small parts are fed to downstream equipment via the conveyor chute.

The entire structure of the storage system is configured in such a way that individual parts of the storage system, in particular those that come into contact with the product, meet the requirements for pharmaceutical transfer in a hermetically sealed enclosure in accordance with the guidelines on “Good Manufacturing Practice for Medicinal Products” (“The Rules Governing Medicinal Products in the European Union, EU Guidelines for Good Manufacturing Practice for Medicinal Products for Human and Veterinary Use”—EU-GMP guidelines), Annex 1 (currently: Volume 4 of Aug. 22, 2022). The enclosure in embodiments has an interface, e.g., an opening with a flange, for example, an alpha port of an alpha-beta port system, to which another gas-tight enclosure, for example, a beta component of an alpha-beta port system, can be connected, in which individual parts of the storage system, in particular autoclaved individual parts, are located. This enables sterile introduction into the enclosure, for example that of a filling or packaging system, in particular in accordance with EU GMP Annex 1.

The individual parts are dimensioned in such a way that they can be inserted into the enclosure via an interface, wherein the largest dimension of a clear cross-section of the interface, for example the alpha port, is less than 270 mm. The clear cross-section has a circular edge, so the dimension refers to the diameter of the outer edge of the clear cross-section. In addition, the storage system can be installed and/or equipped in configurations using a manipulator, for example, an articulated arm robot, in particular a SCARA robot.

### BRIEF DESCRIPTION OF THE DRAWINGS

Further advantages and aspects of the invention are apparent from the claims and from the description of exemplary embodiments of the invention, which are explained below with reference to the figures. The following is shown in the images below:

FIG. 1 a perspective view of an exemplary embodiment of a storage system comprising a storage container, a conveyor chute, and a sorting device.

FIG. 2 an exploded view of the storage system according to FIG. 1;

FIG. 3 a sectional view of the storage container and sorting device of the storage system according to FIG. 1;

FIG. 4 a sectional view of the sorting device and the conveyor chute of the storage system according to FIG. 1;

FIG. 5 a perspective view of the sorting device and the conveyor chute of the storage system according to FIG. 1;

FIG. 6 the sorting device and the conveyor chute of the storage system according to FIG. 1 in a perspective view from below;

FIG. 7 the sorting device according to FIG. 1 in an exploded view;

FIG. 8 another exemplary embodiment of a sorting device similar to FIG. 7 in a perspective view.

FIG. 9 the sorting device according to FIG. 8 in an exploded view.

### DETAILED DESCRIPTION OF THE EXEMPLARY EMBODIMENTS

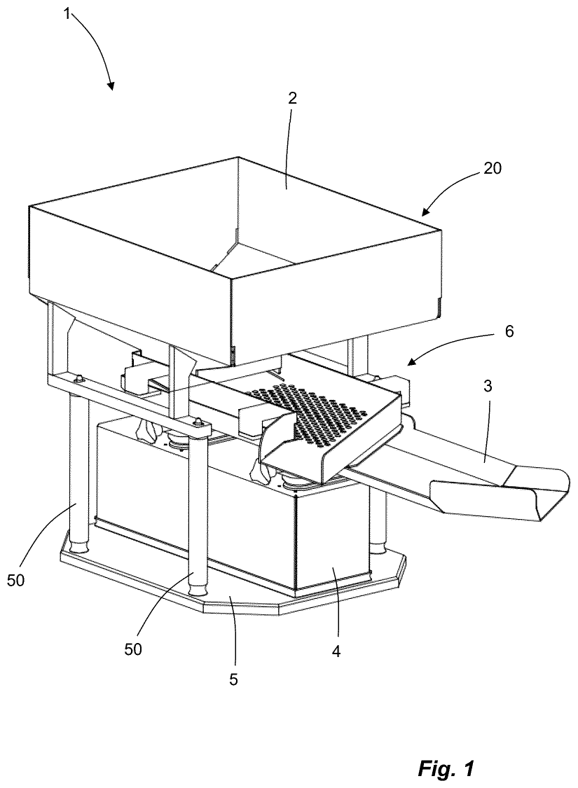

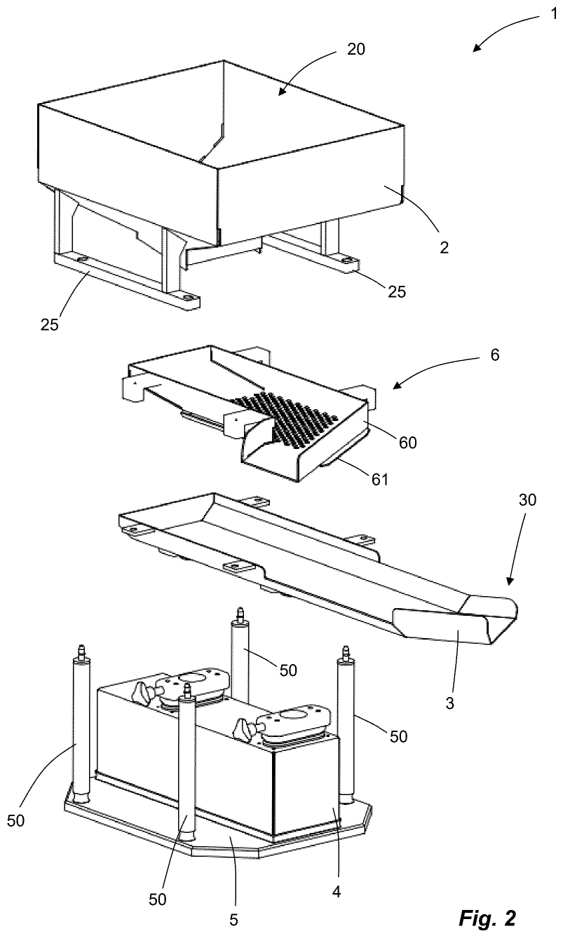

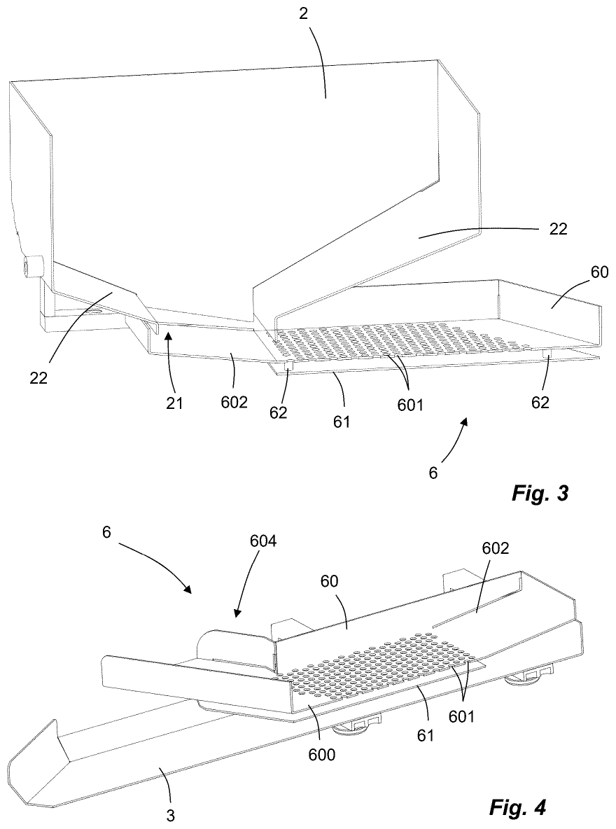

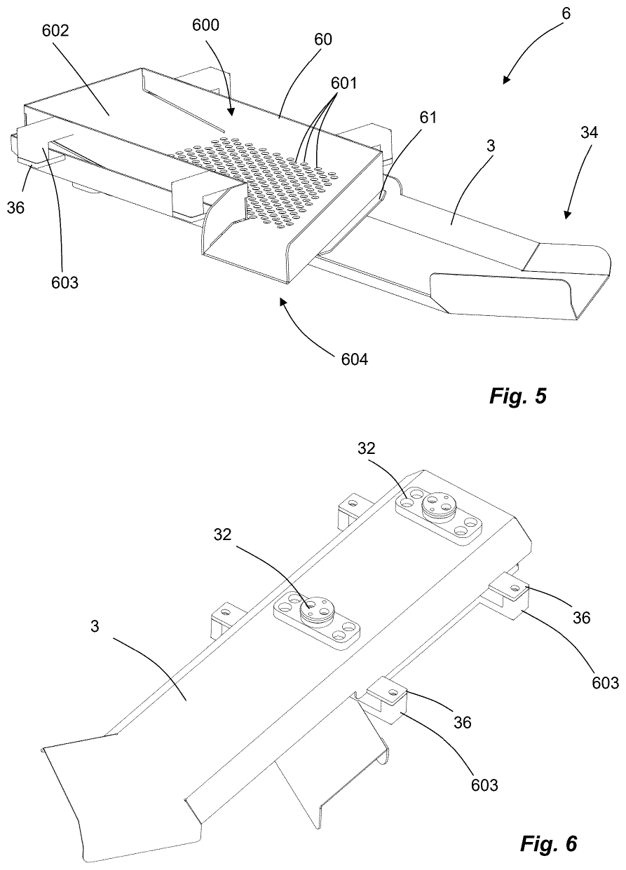

FIGS. 1 and 2 show schematically an exemplary embodiment of a storage system 1 in a perspective view and an exploded view, respectively. FIGS. 3 through 7 show elements of the storage system 1.

The storage system 1 is used for storing and metered dispensing of small parts (not shown)as bulk goods. For example, the small parts are closure elements, in particular stoppers. For example, the closure elements are stoppers for sealing pharmaceutical containers such as vials, cartridges, syringes, or ampoules.

As shown in FIGS. 1 and 2, the storage system 1 comprises a storage container 2 for storing the small parts shown as bulk material.

The storage container 2 has an opening 20 through which the small parts can be introduced into the storage container 2. As can be best seen in FIG. 3, the storage container 2 has an outlet opening 21 in an area located at the bottom in a normal working orientation, through which small parts are discharged from the storage container 2. As can be seen in FIG. 3, walls 22 of the storage container 2 are at least partially inclined so that small parts collected in the storage container 2 are moved toward the outlet opening 21.

As shown in FIGS. 1 and 2, the storage system 1 further comprises a conveyor chute 3 with an outlet 30. The conveyor chute 3 is arranged downstream of the outlet opening 21 of the storage container 2, wherein small parts discharged from the storage container 2 via the outlet opening 21 are moved along the conveyor chute 3 in the direction of a downstream device (not shown in the figures). The downstream device is a device for use with small parts in particular embodiments. For example, the downstream device is a closure device in which containers are sealed with small parts designed as closure elements. The downstream device is, in particular embodiments, a conveyor device with which the small parts are conveyed further towards a device for using the small parts. For example, the system is a feeder for a position-accurate transfer of small parts to downstream filling or packaging/closure systems.

A drive 4 is provided to move the small parts along the conveyor chute 3 toward the outlet 30. In some embodiments, the drive 4 is configured to generate vibrations. The vibrations are transmitted to the conveyor chute 3 to move the small parts in the desired direction of conveying. In particular, in embodiments, the drive 4 is configured to generate vibrations that move the small parts along the longitudinal direction of the conveyor chute 3. Drive 4, for example, is configured as an electromagnetic, mechanical, or pneumatic drive to generate the vibration required to move the small parts. As can be best seen in FIG. 6, coupling elements 32 are provided on the underside of the conveyor chute 3 in order to couple the conveyor chute 3 to the drive for transmitting the vibrations to the conveyor chute 3. In some embodiments, the conveyor chute 3 is connected to the drive 4 by use of a tool-free screw clamp. Coupling is achieved in various embodiments using different clamping systems, e.g., pneumatic, electric, or vacuum systems.

The drive 4 is arranged in configurations on a base plate 5. In some embodiments, columns 50 protrude from the base plate 5, with the storage container 2 being supported by the columns 50. In the exemplary embodiment shown, four columns 50 are provided. The storage container 2 has a support device 25, via which the storage container 2 is supported on the columns 50. In some embodiments, the storage container 2 is supported on one side by the columns 50.

A sorting device 6 is provided between the outlet opening 21 of the storage container 2 and the conveyor chute 3. In the exemplary embodiment shown, the sorting device 6 comprises a separating device 60 and a limiting device configured as a limiting element 61.

The sorting device 6 is configured to separate small parts that adhere to one another or are stuck together and/or to sort out small parts that adhere to one another or are stuck together. The sorting device 6 is configured in particular to separate small parts adhering to each other upstream of the conveyor chute 3 or to sort out small parts adhering to each other upstream of the conveyor chute 3.

In some embodiments, the separating device 60 is attached to the conveyor chute 3, as shown, for example, in FIGS. 4 through 6. The separating device 60 is attached to the conveyor chute 3 in such a way that the separating device 60 is moved with the conveyor chute 3. For example, the separating device 60 and the conveyor chute 3 each have side tabs 36, 603 that stick out to the side when viewed along the length of the conveyor chute. In the exemplary embodiment shown, the separating device 60 is bolted to the conveyor chute 3. For example, the tabs 36 of the conveyor chute 3 have passage holes through which screws (not shown in the figures) can be inserted, which can be screwed into screw channels on the tabs 603 of the separating device 60. For example, the separating device 60 and the conveyor chute 3 each have four tabs 36, 603 that protrude laterally when viewed along the length of the conveyor chute 3.

The separating device 60 is configured as a channel. The separating device 60 has a conveyor surface 600. In the embodiment shown in FIGS. 1 through 7, the conveyor surface has a plurality of passage openings 601. The number, arrangement, and/or dimensions of the passage openings can be selected in particular according to the small parts to be sorted.

In the embodiment shown in FIGS. 1 through 7, the passage openings 601 are suitably dimensioned to retain small parts that adhere to each other, in particular closure elements, such as stoppers. The passage openings 601 are dimensioned in particular so that individual small parts, in particular closure elements, for example stoppers, can pass through the passage openings.

The separating device 60 is excited to vibrate in embodiments; for example, vibrations from the conveyor chute 3 are transmitted to the separating device 60. The movement of the separating device 60 causes the small parts to move along the separating device in the direction of conveyance of the conveyor chute 3. In some embodiments, the movement of the separating device also causes small parts that adhere to one another or are stuck together to come loose.

The separating device 60 has a reject outlet 604. Small parts that do not pass through the passage openings 601 are moved to the reject outlet 604. In particular embodiments, small parts that do not pass through the passage openings 601 are permanently removed from a process operation. In some embodiments, small parts that do not pass through the passage openings 601 are returned to a separate collection container. In some embodiments, small parts that do not pass through the passage openings 601 are returned to the storage container 2.

The reject outlet 604 is arranged transversely, for example at an angle of approximately 45° to approximately 95°, to a longitudinal direction of the conveyor chute 3. In other embodiments, the reject outlet 604 is arranged parallel to the conveyor chute 3. For example, the reject outlet 604 and the conveyor chute 3 are arranged at different levels.

The separating device 60 is configured as a channel and has guide surfaces protruding upward on each of the opposite long sides. The guide surfaces prevent small parts from falling sideways off the separating device 60, ensuring that sorted small parts are transported toward the reject outlet 604.

In the exemplary embodiment shown, the separating device 60 has an inlet 602. A surface of the inlet 602 is inclined relative to the conveyor surface 600, so that the inlet 602 forms a chute through which small parts are conveyed to the conveyor surface 600. The inlet does not have any passage openings 601 in its design.

As can be best seen in FIGS. 3 through 5, in the exemplary embodiment shown, the limiting element 61 is arranged between the conveyor chute 3 and the separating device 60. Spacers 62 are arranged between the separating device 60 and the limiting element 61. The limiting element 61 is arranged at a defined distance below the separating device 60 by means of the spacers 62, so that a gap is formed between the separating device 60 and the limiting element 61. The height of the gap is selected so that only isolated small parts can pass through the gap, thereby separating parts that are stuck together or adhere to one another.

Small parts that adhere to one another and enter a passage opening 601 of the separating device 60 remain stuck in the passage openings 601. Small parts stuck in the passage openings 601 are separated from each other by forces applied to the stuck small parts by subsequent small parts. In the exemplary embodiment shown, the length of the limiting element 61 is selected such that the limiting element 61 extends below the conveyor surface 600. In the exemplary embodiment shown, the length of the limiting element 61 is selected such that the limiting element 61 does not extend below the inlet 602. If there is a blockage in the gap between the limiting element 61 and the separating device 60, small parts can also be moved against the direction of conveyance of the conveyor chute 3 and fall onto the conveyor chute 3 at the rear end of the limiting element 61, viewed in the direction of conveyance of the conveyor chute 3.

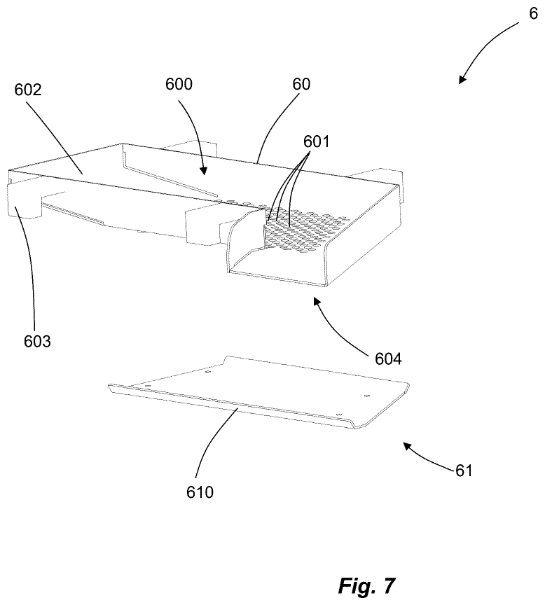

The limiting device 61 is configured as a plate. In other embodiments, the limiting device 61 is configured as a channel, as shown schematically in FIG. 7, and has a guide surface 610 on each of the opposite longitudinal sides, which protrudes in the direction of the separating device 60. The guide surfaces 610 prevent small parts from falling sideways off the limiting device 61.

In some embodiments, no separate limiting element 61 is provided, wherein in particular the separating device 60 and the conveyor chute 3 are arranged in such a way that a gap is formed. The conveyor chute 3 acts as a limiting device. In this case, the gap is dimensioned in such a way that, if possible, only isolated small parts can pass through it.

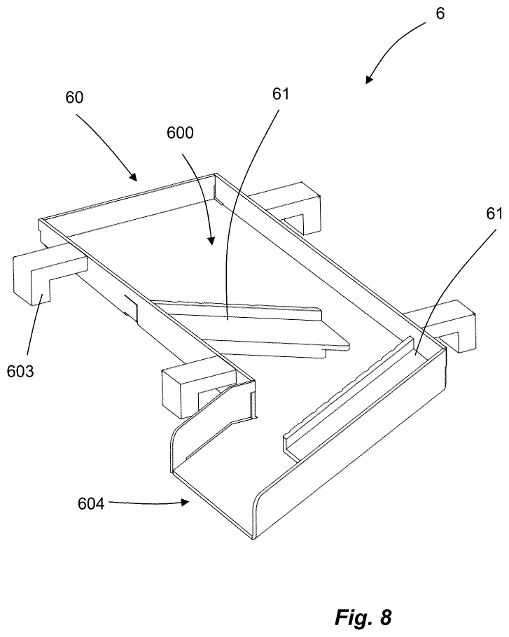

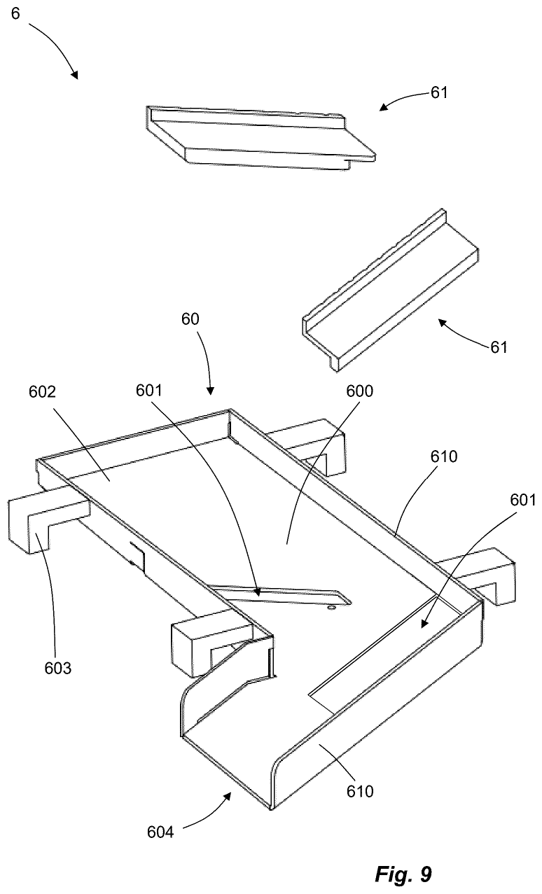

FIGS. 8 and 9 show a further exemplary embodiment of a sorting device 6 similar to the sorting device 6 according to FIGS. 1 through 7 in a perspective view and an exploded view. The sorting device 6 shown in FIGS. 1 through 7 can, for example, be replaced by the sorting device 6 shown in FIGS. 8 and 9 for format adjustment. The sorting device 6 can be installed between a storage container 2 and a conveyor chute of a storage system 1 (see FIGS. 1 and 2).

The sorting device 6 shown in FIGS. 8 and 9 comprises a separating device 60 with a conveyor surface 600 and two limiting elements 61 arranged above the conveyor surface 600 of the separating device 60.

As can be seen in FIG. 9, the conveyor surface 600 of the separating device 60 in the exemplary embodiment shown in FIGS. 8 and 9 has two passage openings 601, wherein small parts conveyed along the conveyor surface 600 can reach the conveyor chute 3 (see FIGS. 1 and 2) via the passage openings 601. Small parts that do not pass through the passage openings 601 are conveyed to a reject outlet 604.

The limiting devices 61 are arranged above the conveyor surface 600. The limiting devices 61 are mounted in particular on the separating device 60. In particular, the limiting devices 61 are mounted on the separating device 60 without the use of tools. The limiting devices 61 each limit a gap with the separating device 60. The limiting devices 61 are each assigned to a passage opening 601. The limiting devices 61 each cover a passage opening 601 so that small parts can only reach the passage opening 601 via a gap formed between the limiting device 61 and the separating device 60.

Small parts that are not isolated, for example, adhering to one another, cannot pass through the gap and are retained. In particular embodiments, the following small parts exert a force on retained, adhering small parts, causing the adhering small parts to separate so that they can pass through the gap.

In embodiments such as those shown in FIGS. 8 and 9, the width of at least one of the limiting devices 61, in particular the first limiting device 61 arranged upstream of a guide surface 610 at the end in the conveying direction, is smaller than the width of the separating device 60 when measured transversely to the conveying direction of the small parts. Small parts that do not pass through the gap formed by the first limiting device 61 can thus pass the first limiting device 61 laterally. Small parts that pass the first limiting device 61 laterally do not reach a passage opening 602 of the separating device 60 covered by the limiting device 61.

In embodiments, the separating device 60, as shown in FIGS. 8 and 9, has at least one further passage opening 601, wherein a further limiting device 61 is assigned to the further passage opening 601. Small parts that do not pass through a gap formed by the limiting device 61 do not reach a passage opening 601. In the exemplary embodiment shown, these small parts are conveyed to the reject outlet 604.

Product-contacting sections of the storage system 1, in particular the storage container 2, the conveyor chute 3, and/or elements of the sorting device 6 have electropolished surfaces in particular embodiments, in particular for use with small parts for pharmaceutical purposes, in particular in accordance with the guidelines of the Food and Drug Administration (FDA guidelines). For less demanding embodiments, some or all product-contacting sections of the storage system feature a glass bead-blasted surface.

### REFERENCE LIST

1 Storage system
2 storage container
3 conveyor chute
4 drive
5 base plate
6 sorting device
20 opening
21 outlet opening
22 wall
25 support device
30 outlet
32 coupling element
36 tab
50 column
60 separating device
61 limiting element, limiting device
62 spacer
600 conveyor surface
601 passage opening
602 inlet
603 tab
604 reject outlet
610 guide surface

What is claimed is:

1. A sorting device for a storage system for small parts, in particular for closure elements, wherein the sorting device is configured to separate small parts adhering to one another and/or to sort out small parts adhering to one another.

2. The sorting device according to claim 1, wherein
the sorting device comprises a limiting device, wherein the limiting device limits a gap.

3. The sorting device according to claim 2, wherein
the gap is dimensioned to allow individual small parts to enter the gap and/or to prevent small parts adhering to one another from entering the gap.

4. The sorting device according to claim 1, wherein
the sorting device comprises a separating device, wherein the separating device has at least one passage opening.

5. The sorting device according to claim 1, wherein
the sorting device comprises a separating device, wherein the separating device has a plurality of passage openings.

6. The sorting device according to claim 5, wherein
the passage openings are dimensioned to allow individual small parts to pass through,
and wherein the passage openings are dimensioned to separate small parts adhering to one another and/or to retain small parts adhering to one another.

7. The sorting device according to claim 4, wherein
the separating device has a conveyor surface with at least one passage opening.

8. The sorting device according to claim 7, wherein
the separating device has an inlet arranged in the conveyor device upstream of the at least one passage opening, wherein the inlet is arranged at an angle to the conveyor surface and forms a chute to the conveyor surface.

9. The sorting device according to claim 1, wherein
the sorting device comprises a separating device having at least one passage opening and a limiting device,
wherein the limiting device limits a gap,
wherein the limiting device is arranged below the separating device in a working orientation of the sorting device, and
wherein the gap is formed between the limiting device and the separating device.

10. The sorting device according to claim 9, wherein
the separating device has a plurality of passage openings.

11. The sorting device according to claim 10, wherein
the passage openings are dimensioned to allow individual small parts to pass through and wherein the passage openings are dimensioned to separate small parts adhering to one another and/or to retain small parts adhering to one another.

12. The sorting device according to claim 1, wherein
the sorting device comprises a separating device having at least one passage opening and a limiting device,
wherein the limiting device limits a gap,
wherein the limiting device is arranged above the separating device in a usage orientation of the sorting device, and
wherein the gap is formed between the limiting device and the separating device.

13. The sorting device according to claim 1, wherein
a width of the limiting device transverse to a conveying direction of the small parts is smaller than a width of the separating device.

14. The sorting device according to claim 1, wherein
the separating device has a reject outlet,
wherein the reject outlet is arranged transversely to a conveying direction of the small parts along the separating device.

15. A storage system for small parts, in particular for closure elements, with at least one sorting device,
wherein the sorting device is configured to separate small parts adhering to one another and/or to sort out small parts adhering to one another.

16. The storage system for small parts according to claim 15, wherein
the storage system comprises a storage container and a conveyor chute,
wherein the sorting device is arranged in the conveying direction of the conveyor chute between the storage container and the conveyor chute.

17. The storage system for small parts according to claim 16, wherein
the sorting device is arranged above the conveyor chute in a working orientation of the storage system.

18. The storage system for small parts according to claim 16, wherein
the sorting device is attached to the conveyor chute.

19. The storage system for small parts according to claim 16, wherein
the sorting device comprises a separating device having at least one passage opening and a limiting device,
wherein the limiting device limits a gap,
wherein the limiting device is arranged below the separating device in a working orientation of the sorting device,
wherein the gap is formed between the limiting device and the separating device, and
wherein the limiting device is arranged between the separating device and the conveyor chute.

20. The storage system for small parts according to claim 16, wherein the sorting device comprises a separating device having at least one passage opening and a limiting device, wherein the limiting device limits a gap, wherein the limiting device is arranged above the separating device in a working orientation of the sorting device, wherein the gap is formed between the limiting device and the separating device, and wherein the limiting device is arranged on a side of the separating device facing away from the conveyor chute.
